(19) United States
(12) Patent Application Publication
(10) Pub. No.: US 2009/0258585 A1
(43) Pub. Date: Oct. 15, 2009

(54) Sanding Surfaces Having High Abrasive Loading

(76) Inventors: Fred Miekka, Arcadia, CA (US); Bola Ajere, Arcadia, CA (US)

Correspondence Address: Denis Khoo;Suite 120, 55 E. Huntington Drive, Arcadia, CA, 91006, US

(21) Appl. No.: 12/489,179

(22) Filed: Jun. 22, 2009

Related U.S. Application Data
(63) Continuation-in-part of application No. 12/209,149, filed on Sep. 11, 2008.
Application No. 12/209,149 is a continuation-in-part of application No. 11/929,963, filed on Oct. 30, 2007.
Application No. 11/929,963 is a continuation-in-part of application No. 11/846,073, filed on Aug. 28, 2007.
Application No. 11/846,073 is a continuation-in-part of application No. 11/828,270, filed on Jul. 25, 2007.
Application No. 11/828,270 is a continuation-in-part of application No. 11/503,058, filed on Aug. 14, 2006.
(60) Provisional application No. 60/764,110, filed on Feb. 1, 2006.
(60) Provisional application No. 60/818,571, filed on Jul. 5, 2006.

(51) Int. Cl. B24D 15/02; C09K 3/14

(52) U.S. Cl. 451/523; 51/298

(57) ABSTRACT

Abrasive articles are disclosed that may be used in dry sanding applications. The abrasive articles disclosed may be made entirely from abrasive materials or alternatively may be made by fastening abrasive surfaces to handles or tools. The abrasive articles of the present invention have abrasive surfaces with controlled wear rates that renew themselves during use. The self renewing abrasive surfaces of the present invention may be prepared by pressing a mixture of abrasive particles and a minimal amount of a foam binder together into a mold and subsequently allowing the mixture to foam, break down, and harden. Alternatively, high loading densities of abrasive with larger amounts of foam binder may be employed that retain their foam integrity. The resulting abrasive articles are long lasting and may be made low in cost.

### CROSS REFERENCES TO RELATED APPLICATIONS

This is a Continuation-in-Part of prior application Ser. No. 12/209,149 filed on Sep. 11, 2008 which is a Continuation-in-Part of Ser. No. 11/929,963 filed on Oct. 30, 2007 which is a Continuation-in-Part of Ser. No. 11/846,073 filed on Aug. 28, 2007 which is a Continuation-in-Part of Ser. No. 11/828,270 filed on Jul. 25, 2007 which is a Continuation-in-Part of Ser. No. 11/503,058 filed Aug. 14, 2006, which claimed priority to provisional application No. 60/764,110 filed on Feb. 1, 2006 and provisional application No. 60/818,571 filed on Jul. 5, 2006. Each of the above listed applications is incorporated herein by reference in their entirety.

### BACKGROUND OF THE INVENTION

1. Field of the Invention

This invention relates to abrasive articles. More particularly this invention relates to abrasive articles having wearable abrasive surfaces. The wearable abrasive surfaces of the present invention are comprised of rigid closed cell polymeric foam materials having very high loading densities of abrasive materials such as aluminum oxide and silicon carbide. The density of the polymeric foam may be adjusted for optimum controlled rates of wear. The wearable abrasive articles of the present invention may be used on power sanding tools for automotive applications such as straight-line and dual action sanders.

2. Description of the Related Art

There are numerous methods that may be employed to sand surfaces. One of the more common methods employs sand paper. Sand paper is a thin sheet material usually made of paper that has an abrasive material securely bonded onto one side. Despite its name, the abrasive is rarely if ever sand. Commonly used abrasives such as aluminum oxide and silicon carbide are significantly harder than sand and are therefore more effective. This may be especially true when sanding hard materials such as glass or steel.

Sand paper may be used by hand. This process is often referred to as hand sanding. The process of hand sanding involves using manual labor to repeatedly slide the sand paper back and forth and/or in a circular motion over the surface until smooth. Numerous textures of abrasives are available. Often sanding starts out with a relatively course grade of sand paper of about 80 grit followed by finer grades of several hundred grit to finish the job.

One drawback often associated with sand paper is the tendency of producing dust that clogs the sand paper. One way to alleviate this problem is by using wet or dry Emery cloth. Wet or dry Emery cloth is an abrasive coated cloth having a wide variety of grades. It is designed for use with water thereby reducing clogging effects.

Another drawback with using sand paper is the tendency for the abrasive to become dull and fall off from the sand paper backing surface.

Sanding by hand using sand paper is not always practical owing to the amount of labor required. This is especially true for large jobs that may take a long time resulting in fatigue.

In order to alleviate the worker fatigue issue in hand sanding operations, numerous power sanding techniques and/or equipment have been developed. Drum sanding, belt sanding, disc sanding, and orbital sanding are commonplace. These standard power sanding tools often employ some form of sand paper and therefore often suffer from many of the previously mentioned drawbacks. In particular is the need to change the sanding surface at regular intervals.

Numerous modifications to ordinary sand paper have been made in order to improve the overall process. For example, sand paper having a lowered surface density of abrasive particles is available. This particular sand paper is made by 3M Corporation of ST. Paul Minn. and is designed for use in sanding relatively soft materials that quickly gum up ordinary sand paper. Significant improvements in sand paper life may be realized by reducing the tendency of particulate matter to clog the needed spaces between adjacent abrasive particles.

Another improvement that may be made to ordinary sand paper involves the use of flexible and conformable foam backing. Such backing materials allow the sand paper to conform to surface contours thereby more rapidly smoothing contoured surfaces. Individual pieces of sand paper may be applied to foam pads or conversely, foam pads having previously attached sand paper may be employed. For example, Finishing Buddies (Mona Lisa Products 10770 Moss Ridge Road Houston, Tex., 77043) is a complete sanding tool kit consisting of a steel wool pad, oval sanding disc, and coarse, medium, and fine sanding pads. The oval pad is relatively rigid, and the three other sanding pads have a softer foam backing that has a greater degree of flexibility. This sanding kit is designed for slow hand sanding and finishing operations.

There are numerous flexible sanding surfaces, components, and articles comprised of abrasive materials fixedly attached to flexible foam backings. Of particular interest is a sanding system employing a relatively thin rigid foam backing disclosed in U.S. Pat. No. 6,923,840 and assigned to 3M Innovative Properties Company, St. Paul Minn. (US). U.S. Pat. No. 6,923,840 discloses a flexible abrasive product comprised of an open cell foam backing, a foraminous barrier coating, and a shaped foraminous abrasive coating. The top abrasive coating is discontinuous and allows for holding lubricants such as water as well as spaces for removal of debris.

U.S. Pat. No. 6,949,128 also assigned to 3M, discloses a method for making a foam backed abrasive article having embossed raised areas.

U.S. Pat. No. 3,401,490 discloses a method for forming an abrasive article having a resiliently yielding open cell meltable base which is passed under a heated roll to melt the surface to a desired depth followed by application of abrasive particles to the melted surface. The result is a flexible foam based abrasive article capable of following irregular, uneven, or sunken surfaces.

U.S. Pat. No. 6,997,794 by James Matthew Pontieri discloses a disposable sanding device fabricated as a continuous rope like article adapted for selective segmentation. This device may employ a foam central portion along with an abrasive outer portion. In particular the flexible cylindrical geometry illustrated in several embodiments of the invention lends itself to the hand sanding of difficult to reach contours and may prove especially useful in woodworking applications.

There are numerous flexible foam based cleansing and scouring pads having added abrasive materials. An example of this can be found in U.S. Pat. No. 3,377,151. U.S. Pat. No. 3,377,151 discloses a method for making flexible resilient cleansing and scouring pads having an abrasive surface. A thermoplastic foam web material is hot laminated to abrasive web material. In addition, one or more cleansing materials may be added.

U.S. Pat. No. 3,619,843 discloses sponges having dry impregnated materials. In this invention, impregnated sponges are prepared by a process that deposits particulate material on one surface of the sponge and subsequently pierces the sponge with spikes to form crevices followed by drawing particulate material into the crevices. The result is a modified sponge suitable for surgical and sanitizing applications.

Also of interest are flexible open cell foam scouring and cleaning pads having numerous protrusions. These pads are disclosed in U.S. Pat. No. 4,055,029 by Heinz Kalbow, Lichgasse. The flexible pad has numerous protrusions on the working surface having an abrasive layer. U.S. Pat. No. 4,111,666 also by Heinz Kalbow discloses a method of manufacturing flexible abrasive cleaning pads along with improvements in tear resistance.

U.S. Pat. No. 4,421,526 discloses polyurethane foam cleaning pads composed of a densified flexible sponge like polyurethane foam material impregnated with various cleansing additives. Excessive mixing of the freshly blended polymers inhibits foam formation long enough to add the cleansing ingredients. The resulting pads have added strength due to collapsed, ruptured, and distorted cells along with fibers that result from the specific mixing process employed. The result is an unusually strong dense flexible cleaning pad capable of absorbing substantial amounts of water that releases additives along with absorbed water on gentle squeezing.

U.S. Pat. No. 4,594,362 discloses a dry type textile cleaning article comprised of a friable hydrophilic polyurethane foam with incorporated abrasive particles as well as other additives. The abrasive particles are chemically bonded to the foam using silane coupling agents thereby reducing their tendency to separate from the mass and subsequently damage cloth material.

Wet sanding abrasive foam compositions are disclosed in U.S. patent application #20080020678 titled “Discontinuous Abrasive Particle Releasing Surfaces” having serial #828270. In this invention, water softening properties are imparted to an abrasive loaded foam surface to prevent deep scratches from coarse abrasive particles, and to aid in abrasive paste formation. Attempting to use these wet abrasive compositions in dry sanding operations results in an abrasive surface that dulls, clogs up and may not have the proper controlled rate of wear.

While the above described examples of foam based abrasive articles provide a wide variety of uses, there exists a need in the art for semi-rigid or rigid abrasive articles having a wearable surface that renews itself during use that may be employed in hand and/or low speed abrasive operations including sanding, and/or grinding operations.

Many of the above described examples outline the use of foam with abrasive materials in order to achieve certain advantageous and desirable properties. Still others outline some of the more simple methods and materials commonly employed in sanding, and grinding. While generally effective for sanding, and grinding, there exists a need in the industry for further improvements in abrasive operations.

For example, improvements in abrasive operations may be realized in the area of dual action sanding tools. Dual action sanding tools employ the action of simultaneous spinning and vibration. This dual action results in rapid and relatively uniform sanding. Dual action sanding tools may be used with the sanding compositions outlined in the present invention to provide continuous non-clogging use. Additionally, The action of straight-line sanding tools tends to reduce clogging effects when sanding surfaces with the sanding compositions outlined in the present invention as well.

Despite numerous advancements in the field of abrasives there is a need for abrasive articles having a wearable surface that renews itself during use that may be employed in abrasive operations.

It is an object of this invention to provide abrasive surfaces for hand sanding applications.

It is a further object of this invention to provide numerous grades of abrasive surfaces for low speed hand sanding applications.

It is a further object of this invention to provide abrasive surfaces sanding applications employing dual action and straight-line sanding tools resistant to excess build up of debris.

It is a further object of this invention to provide abrasive surfaces for both hand and power sanding applications having a controlled level of rigidity.

It is a further object of this invention to provide abrasive surfaces for both hand and power sanding applications that are low in cost.

It is a further object of this invention to provide simple methods for producing abrasive surfaces for hand and power sanding applications.

It is a further object of this invention to provide abrasive surfaces for hand and power sanding applications that may be used for extended periods of time without wearing out.

It is a further object of this invention to provide abrasive surfaces for hand and power sanding applications that do not produce excessive surface scratching.

Finally, it is an object of this invention to provide abrasive surfaces for hand and power sanding applications that have wear rates that result in continuous renewal of working surfaces during use.

### SUMMARY OF THE INVENTION

This invention proposes articles for sanding applications employing wearable abrasive surfaces that renew themselves on continued use. The sanding articles of the present invention have wearable abrasive surfaces comprised of closed cell rigid polymeric foam loaded with large amounts of abrasive particles. Dense wearable abrasive surfaces may be formed by compressing a mixture of abrasive particles with a minimal amount of liquid polyurethane foam resin together. Compression of the above described wearable abrasive surfaces may be take place in a mold thereby forming them into specific shapes. Wearable abrasive surfaces of a lower density may be formed by mixing substantial amounts of abrasive particles together with liquid polyurethane foam resins having an overall density of 8 or more pounds per cubic foot.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 shows an abrasive surface suitable for Velcro (hook and loop) attachment to a straight-line sander.

FIG. 2 shows a cross sectional view of a dense abrasive composition of the present invention.

FIG. 3 shows an abrasive article suitable for Velcro (hook and loop) attachment to a dual action sander.

FIG. 4 shows a cross sectional view of a foam based abrasive surface suitable sanding applications.

FIG. 5 shows a cross sectional view of a sanding disk having Velcro (hook and loop) attachment means for a rotary or dual action tool.

FIG. 6 shows a hand held abrasive article suitable for hand sanding applications comprised of a handle portion fixedly attached to wearable abrasive surface.

FIG. 7 shows a dual action sanding pad having a pattern of two different foam abrasive compositions.

### DETAILED DESCRIPTION OF THE INVENTION

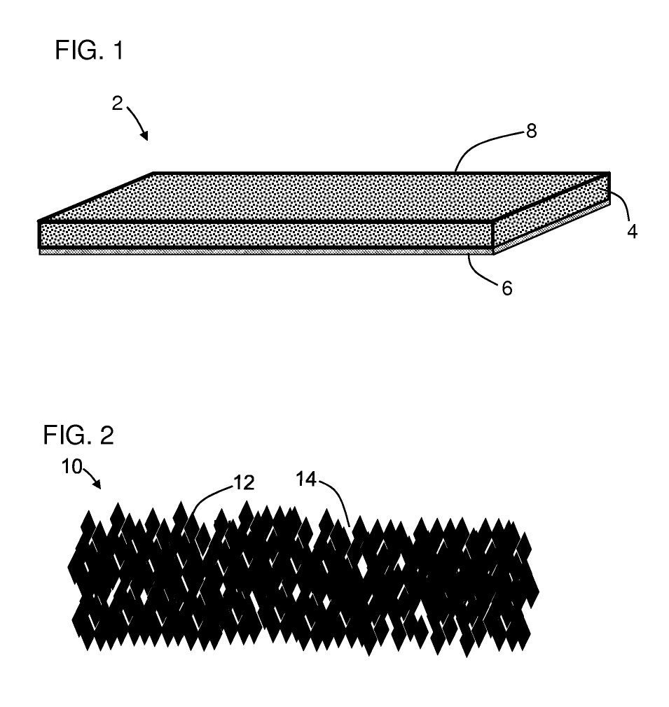

FIG. 1 shows an abrasive surface suitable for Velcro (hook and loop) attachment to a straight-line sander. Abrasive straight line sanding pad 2 is shown having top abrasive pad portion 4 attached to soft Velcro (hook and loop) attachment portion 6. Also shown is top exposed major sanding surface portion 8. Straight line sanding pad 2 attaches to a straight line sanding tool with Velcro (hook and loop) attachment portion 6.

FIG. 2 shows a cross sectional view of a dense abrasive composition of the present invention. Dense abrasive composition 10 is shown having hard abrasive particles 12 along with spaces 14 between hard abrasive particles 12. Spaces 14 between hard abrasive particles 12 provide separation between hard abrasive particles 12. This separation allows for exposure of individual hard abrasive particles 12 while at the same time providing space for debris generated during the sanding process.

The dense abrasive composition of FIG. 2 forms when there is not enough liquid polymeric foam resin in the mix to properly foam. Dense abrasive compositions form at an abrasive loading density of about 90% by weight of the mix. This value is dependent on the polymeric resin system, the abrasive material, and the abrasive particle size. Dense abrasive compositions of the present invention may used to produce working tools having a controlled rate of wear. Abrasive compositions of this nature may be made to work for hand sanding as well as power sanding applications. Abrasive compositions employing 92% by weight of silicon carbide abrasive to 8% by weight of liquid polymeric foam resin exhibit desirable sanding properties having surfaces that renew themselves at a good rate and are resistant to clogging effects from prolonged use. The following examples will now be given in detail.

### Example 1

8 grams of polyurethane resin A SP-328-8 from Silpak (Silpak INC 470 East Bonita AVE Pomona, Calif. 91767 Tel # (909) 625-0056) were placed into a 1 liter polyethylene wide mouthed container. To this were added 8 grams of polyurethane resin B SP-328-8 from Silpak. These two resins were then blended together and mixed thoroughly. 184 grams of 120 grit silicon carbide abrasive were then added and mixed thoroughly with an electric mixer to form a damp powder. This damp powder was then placed into a 2½″×4½″×1″ deep cavity of a silicone mold. This mixture was then compressed with a wooden block by applying about 40 pounds of pressure for a period of one minute. The wooden block was then removed and the mixture allowed to cure for 20 minutes. The partially cured part was then removed from the mold. The bottom surface was then sanded down to open and expose an abrasive surface. Sandblasting may also be employed in opening and exposing the abrasive surface. The part was then allowed to stand for 24 hours to thoroughly cure. This part was then attached to a plastic handle with polyurethane adhesive. Once cured, the tool was used to sand automotive paint and primer from a metal surface. Sanding was rapid. The sanding surface released abrasive particles at a rate sufficient to renew the surface without dulling. The working surface of the tool had little tendency toward plugging up. This tool behaved in a similar manner to 320 grit sandpaper. Furthermore, despite the fact that 120 grit abrasive was used to make the tool, deep scratches were not observed.

### Example 2

The above experiment was repeated using 46 grit silicon carbide abrasive. Results were substantially the same with the sanding surface of the tool behaving like 100 grit sandpaper.

Samples of both abrasive materials outlined above were broken off from the tools. Microscopic examination revealed about 50% void space with no evidence of closed cells. No foam structure was present. The abrasive particles were spaced uniformly throughout the mix forming an aggressive abrasive composition. This clearly shows that the 92% abrasive loading density in the mix was sufficient to disrupt the formation of foam. Disruption of the foam may be said to have occurred when bubbles normally present in the foam are no longer discernable under microscopic examination.

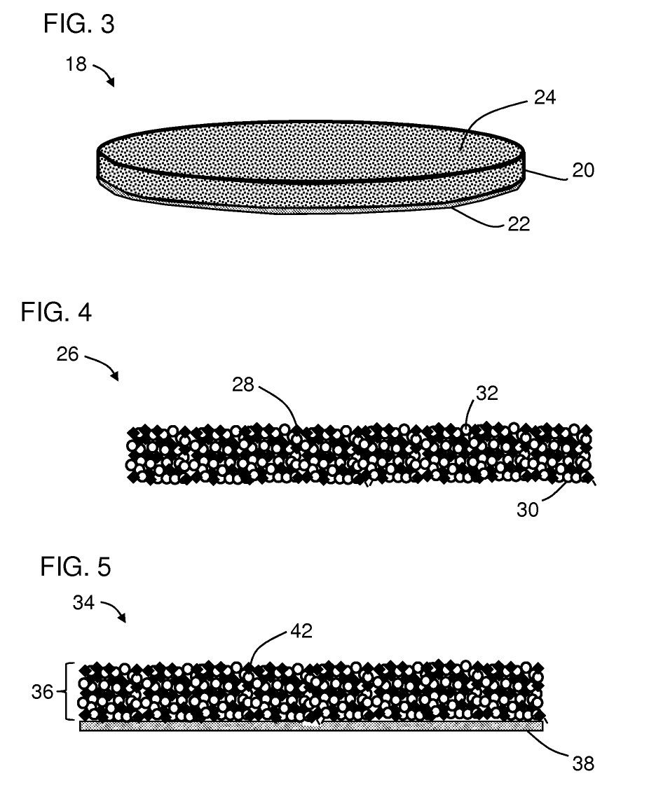

FIG. 3 shows an abrasive article suitable for Velcro (hook and loop) attachment to a dual action sander. Abrasive dual action sanding pad 18 is shown having top abrasive pad portion 20 attached to soft Velcro (hook and loop) attachment portion 22. Also shown is top exposed major sanding surface portion 24. Dual action sanding pad 18 attaches to a Dual action sanding tool with Velcro (hook and loop) attachment portion 22. Dual action sanding pads attach to dual action sanding tools. Dual action sanding tools combine the simultaneous actions of both spinning and vibration. These two combined actions help to remove debris from the sanding area thereby reducing clogging effects that may occur at exposed major sanding surface portion 24 during use.

FIG. 4 shows a cross sectional view of a foam based abrasive surface suitable sanding applications.

Abrasive material 26 is shown in cross sectional view. Abrasive material 26 is shown having abrasive particles 28 embedded within high density foam matrix material 30. Abrasive particles 26 may comprise a material selected from the group consisting of aluminum oxide, silicon carbide, zirconia, diamond, ceria, cubic boron nitride, garnet, ground glass, quartz, and combinations thereof. Also shown are voids 32. Voids 32 result from the foaming action of the polymeric foam based resin materials employed.

Foam based sanding compositions may be prepared by blending substantial amounts of silicon carbide abrasive with liquid polyurethane foam resins having a density of 8 or more pounds per cubic foot. These higher density foam compositions may be loaded with larger amounts of abrasive without falling apart. This may require the use of low viscosity resin materials or alternatively may be prepared by thinning down higher viscosity resin materials with a non-reactive solvent. Additionally, solvents having some reactivity toward the isocyanate portion of the mix may be added to modify the foaming characteristics of the mix. Non-reactive solvents include solvents having enough polarity do be compatible with both the polyol and isocyanate resins but lacking reactive functional groups. Generally speaking, hydroxyl groups are reactive toward isocyanate resins. Alcohols and ketones having enol alcohols (enol keto tautomerization) may react with isocyanate resins and should be considered reactive with the system.

Additionally, the resin ratio of polyol resin to isocyanate resin should be close to stoicheometric. One practice used in the industry is to use a very slight excess of isocyanate resin in the mix of about one percent by weight. Although both flex agents as well as stiffening agents may be added to modify resin properties, working abrasive compositions have been made that work in straight-line sanding tools without these additives. Additionally, Working compositions have been prepared for dual action sanding tools by limiting the thickness of the abrasive surface to 0.2″. This limited thickness allows for some tool flexibility without the need to use flex agents. Abrasive loading density and foam density may then be used to provide a suitable tool life without the need to increase the thickness of the abrasive surface. Flexibility additives may be employed to dampen vibration effects of power tools, improve the ability of the sanding surface to follow contours, and improve tool life.

Flexibility agents may also be used to soften the working surfaces of sanding pads thereby preventing deep scratches formed when highly exposed and freshly shed abrasive particles are rubbed against the sanding surface during use.

Of particular interest are soft flexible polyurethane foam materials. These materials may be added to rigid polyurethane foam mixtures to render them less stiff, softer, and more flexible. Dual action sanding pads having a 320 grit value were prepared in the standard 6″ diameter round format. Into a one gallon pail were placed 280 grams of A isocyanate SP 328-16 (rigid 16# polyurethane foam from Silpak) along with 48 grams of A isocyanate SP 100-8 (flexible 8# foam from Silpak). In a separate one quart polyethylene container were placed 240 grams of B polyol SP 328-16 (rigid 16# polyurethane foam from Silpak) along with 104 grams of B polyol SP 100-8 (flexible 8# foam from Silpak) and 20 grams of acetone. The polyol mixture in the one quart container was thoroughly mixed at room temperature. 354 grams of this blended polyol mix were transferred to the one gallon pail with the isocyanate resin mixture. The contants of the one gallon pail were then mixed for about 30 seconds. 1,900 grams of 90 grit aluminum oxide abrasive were then added to the contents of the pail and thoroughly mixed with a power mixer. After about 30 seconds of this mixing, the contents of the pail were then transferred to a 6″ diameter cylindrical mold in a vertical configuration and allowed to cure overnight. The following day, the resultant loaf was removed from the mold and sliced into 0.2″ lengths with a diamond blade. Velcro (hook and loop) pads were then laminated to one side of the 0.2″ sanding pads using a flexible polyurethane bonding agent. The above described sanding pads behaved in a similar manner to 320 grit sandpaper but did not dull or slow down from continued use. The wear rate of these pads was measured and found to be about 0.002″ per minute. This rate of wear would provide just under two hours of continuous sanding time per pad.

The density of polyurethane foam materials may be increased by blending non-foaming polyurethane resins with foaming polyurethane resins. In certain circumstances it may be desirable to blend foaming polyurethane resins with non-foaming polyurethane resins in order to increase foam density, modify surface hardness, and control bubble size and uniformity. This blending is easily carried out by thoroughly mixing the resins prior to adding the abrasive.

Sanding rates may be improved by blending abrasives. Coarse abrasive particles may be employed to improve sanding speed without producing deep scratches. This can be achieved by blending fine and coarse abrasives together. For example, sanding pads made from 90 grit abrasive particles give scratch patterns similar to fresh 320 grit sandpaper. If however, a slightly finer grit of about 100 is blended with a coarser abrasive of about 70 grit, faster sanding may be achieved. The 70 grit abrasive particles will sand faster and the finer particles will smooth out deep scratches. The finer grit abrasive may be a better grade to assure that any deep scratches formed from the coarse grit abrasive particles are sanded smooth. In addition, adding more flexibility and softening of the sanding pads can be used to further inhibit the formation of deep scratches from the coarse abrasive. An example is illustrated below.

In a one gallon polyethylene plastic pail were placed 120 grams of 120 degree F. Silpak SP-328-4 A four pound rigid foam polyurethane isocyanate resin. To this were added 28 grams of 120 degree F. Silpak SP-100-8 A 8 pound flexible foam polyurethane isocyanate resin. To this were then added 40 grams of 120 degree F. Silpak siltec 75 polyurethane isocyanate resin. In a separate 1 quart polyethylene container were placed 110 grams of 120 degree F. Silpak SP-328-4 B four pound rigid foam polyurethane polyol resin. To this were added 66 grams of 120 degree F. Silpak SP-100 B 8 pound flexible foam polyurethane polyol resin. To this were then added 44 grams of 120 degree F. Silpak Siltec 75 polyurethane polyol resin. To this were then added 10 grams of Silpak SP-328-2 B two pound rigid foam polyol resin. The contents of the one quart container were thoroughly mixed until uniform. 210 grams of the polyol mixture in the one quart container were then added to the isocyanate resin mixture in the one gallon polyethylene container. The contents of the one gallon container were then mixed with a drill mixer until the resin mixture started to clarify followed by the addition of 20 grams of turpentine. The mixture was then mixed again for a period of 20 seconds until clarification was complete. The abrasive mixture consisting of 585 grams of 100 grit sandpaper grade aluminum zirconium oxide (100 N Z Plus Alum/Zirconia) from Washington Mills (Washington Mills North Grafton, Inc, 20 N. Main St, North Grafton, Mass. 01536, Tel: +1 508-839-6511) and 585 grams of 70 grit aluminum oxide at 85 degrees F. was then added to the contents of the plastic pail and mixed for 30 seconds with a drill mixer. This mixture was then poured into a 6″ diameter cylindrical mold and allowed to cure for one hour. The hardened foam composition was then cut into 0.2″ thick 6″ diameter circles. These sanding pads were then allowed to cure overnight, bonded to Velcro (hook and loop) backing, and tested. Sanding of automotive primed panels gave results similar to 320 grit sandpaper. Sanding speed was rapid, and the resulting scratch pattern on the primer was similar to 320 grit sandpaper.

The above described composition employed increased amounts of flexible polyurethane foam as well as polyurethane resin used to strengthen the lower density 4# foam used. Elevated temperature of the resins reduced their viscosity and improved comparability. Once the 120 degree F. resins formed a true solution and were thoroughly mixed, the addition of the cooler 85 degree F. abrasive slowed the foaming reaction down to a manageable level. The 30 second mixing time after addition of the abrasive assured a thorough mix and gave enough time to partially disrupt the foam structure. This partial disruption of the foam structure results from over mixing. Over mixing of the foaming polyurethane resin causes coalescence of bubbles to produce larger bubbles, and out gassing. The sanding pads produced in this way had fewer and larger voids along with increased foam density.

Bubble size and overall foaming properties of the foam abrasive compositions of the present invention may be modified by the mixing procedure. For example, isocyanate resin materials may be blended together in one container, and polyol resin materials blended in a separate container. These resin mixtures may be heated to a moderate temperature in order to reduce viscosity and increase resin compatibility without the need to use solvents. These resin mixtures may then be blended in proper proportion followed by adding the abrasive to the blended resin mixture. The abrasive may be of a significantly lower temperature than the resin mix. The addition of the cooler abrasive serves to slow the polymerization reaction enough to allow for foam expansion prior to the resin becoming excessively hard. In addition, this blending of the cooler abrasive slows the reaction down to allow for more mixing time without disrupting bubble formation. Proper bubble formation is important for making tools that retain their foam integrity. The bubbles in the finished mixture provide spaces for debris to go during sanding, provide cutting surfaces at their edges, and reduce the density of the finished foam material. Controlling the density of the finished foam material results in an abrasive foam composition that may be cut with industrial diamond tooling without rapid wear of cutting blades. In addition, controlling the density of the foam provides a way of controlling the overall weight of the finished sanding pads. Sanding pads having excessive weight may cause excessive vibration issues during use in dual action sanding tools.

Non-foaming polyurethane resin additives may be used in numerous ways to affect the final properties of the finished tools. For example, the resin additive may be allowed to polymerize to a significant molecular weight prior to addition to the reacting foam composition. In this case small amounts of resin additive may exhibit significant improvements in overall tool strength and allow for higher abrasive loading in sanding pads. This approach may present some difficulties in manufacturing since the degree of polymerization must be significant, but the polymerizing resin additive must still be low enough in molecular weight to remain liquid. An alternative to this approach is the use of a solvent to thin down this resin additive and keep it in a liquid state for a prolonged period of time.

Another way to modify the foam with non-foam resins is to add the isocyanate portion of the non-foam resin to the foam isocyanate resin mix and to add the non-foam polyol to the polyol resin mix. This method of addition may be employed to add significant amounts of non-foam resin to the abrasive foam compositions of the present invention.

Low density polyurethane foam resins may be employed with substantial amounts of hard polyurethane non-foam resins to control foam density, bubble size, and rate of wear. Described below is an example of a polyurethane abrasive foam composition employing a high amount of a hard non-foam polyurethane resin additive.

Into a one gallon pail were placed 122 grams of (120 degree F.) A isocyanate SP 328-4 (rigid 4# polyurethane foam from Silpak) along with 20 grams of (120 degree F.) A isocyanate SP 100-8 (flexible 8# foam from Silpak) and 110 grams of (120 degree F.) A isocyanate siltec 75 (hard non-foaming polyurethane resin from Silpak). In a separate one quart polyethylene container were placed 163 grams of B polyol SP 328-4 (rigid 4# polyurethane foam from Silpak) along with 50 grams of B polyol SP 100-8 (flexible 8# foam from Silpak) and 132 grams of B polyol siltec 75 (hard non-foaming polyurethane resin from Silpak). The polyol mixture in the one quart container was thoroughly mixed at an elevated temperature of 120 degrees F. 294 grams of this blended polyol mix were transferred to the one gallon pail with the isocyanate resin mixture. The contents of the one gallon pail were then mixed for about 30 seconds. During this time the resin clarified. 1,600 grams of (85 degree F.) 90 grit aluminum oxide abrasive were then added to the hot clear contents of the pail and thoroughly mixed with a power mixer. After about 30 seconds of this mixing, the contents of the pail were then transferred to a 6″ diameter cylindrical mold in a vertical configuration and allowed to cure overnight. The following day, the resultant loaf was removed from the mold and sliced into 0.2″ lengths with a diamond blade. Velcro (hook and loop) pads were then laminated to one side of the 0.2″ sanding pads using a flexible polyurethane bonding agent. The resulting pads exhibited good sanding properties and had good wear properties.

The abrasive loading density needed for these tools requires about 270 grams of silicon carbide and/or aluminum oxide abrasive for each 100 grams of resin mix. Below this value, sanding is slow and surface clogging may occur. This ratio of abrasive to resin mix results in structural integrity. A foam may be considered to have structural integrity if bubbles in the foam remain intact once cured.

In order to provide the needed abrasive loading for these tools, resin viscosities should be limited so that the abrasive can be blended in sufficient quantities and still be poured into molds. Resin viscosities can be reduced by elevating their temperature and/or by the addition of solvents.

The abrasives themselves may have various particle shapes. Silicon carbide abrasives tend to be somewhat planar. Because of this, there is a tendency of silicon carbide abrasive particles to align themselves in the direction of foam growth during manufacture. Sanding surfaces cut at right angles to foam growth may therefore exhibit better sanding properties than sanding surfaces cut along the direction of foam growth. Additionally, it may be desirable to blend different abrasive materials having the same grit value together to provide sanding surfaces having improved properties.

Aluminum oxide abrasive tends to be less planar than silicon carbide and may be less sensitive to the particular direction of orientation. It should be noted that it is common practice to employ silicon carbide in wet sanding materials such as wet emery cloth, and to employ aluminum oxide in sandpaper used in dry applications.

Wear rates may be controlled by modifying the density of the foam, this may include the addition of non-foaming polymer resins that may further enhance the strength of the foam composition. Additionally, when using coarse abrasive grit sizes of about 60 grit and coarser, some abrasive foam compositions may have a marked tendency to shed free abrasive particles. In these instances it may be desirable to coat the abrasive particles with the non-foaming resin used in the foam composition. This is easily achieved by mixing freshly prepared liquid resin with the dry coarse abrasive to coat their exposed surfaces. The amount of resin needed is on the order of 1% by weight of abrasive. Coating coarse abrasive particles in this manner results in a substantial reduction of abrasive shedding. Further improvements may be achieved by adding the coated abrasive to the foam prior to complete curing of the resin coating on the abrasive particles. Additionally, the resin ratio may be modified for the coating on the abrasive in order to give a surface having reactive functional groups to the foam resin mixture used in the abrasive foam compositions of the present invention.

Coarse abrasive particles may also be coated with resin followed by addition of a finer abrasive prior to curing in order to form abrasive agglomerates consisting of coarse particles coated with finer particles. An example of this is illustrated below.

5 grams of siltec 75 A isocyanate were placed into a small container. To this were added 5 grams of siltec 75 B polyol. The resins were then mixed until uniform. 2.0 grams of this liquid resin mixture were added to 150 grams of 46 grit aluminum oxide abrasive. The abrasive was then mixed with the resin until thoroughly uniform. This mixture was then allowed to partially cure for a period of 2 minutes. 50 grams of 100 grit aluminum zirconium oxide abrasive from Washington Mills were then added and mixed into the partially cured mixture of 46 grit abrasive. Mixing was carried out long enough to give a uniform mixture. The resin was then allowed to completely cure. Microscopic examination revealed agglomerates comprised of individual 46 grit abrasive particles having an average of three 100 grit particles firmly attached. The resulting agglomerates have finer abrasive protrusions extending out from the coarser resin coated abrasive particles. This modified shape of abrasive particles in combination with the resin coating may significantly reduce abrasive shedding.

FIG. 5 shows a cross sectional view of a sanding disk having Velcro (hook and loop) attachment means for a rotary or dual action tool. Abrasive dual action sanding pad 34 is shown having top abrasive pad portion 36 attached to soft Velcro (hook and loop) attachment portion 38. Also shown is top exposed major sanding surface portion, on the opposite side of the Velcro (hook and loop) attachment 38. Dual action sanding pad 34 attaches to a Dual action sanding tool with Velcro (hook and loop) attachment portion 38. Dual action sanding pads attach to dual action sanding tools. Dual action sanding tools combine the simultaneous actions of both spinning and vibration. These two combined actions help to remove debris from the sanding area thereby reducing clogging effects that may occur at exposed major sanding surface portion during use. Exposed abrasive particles 42 are shown protruding from major sanding surface.

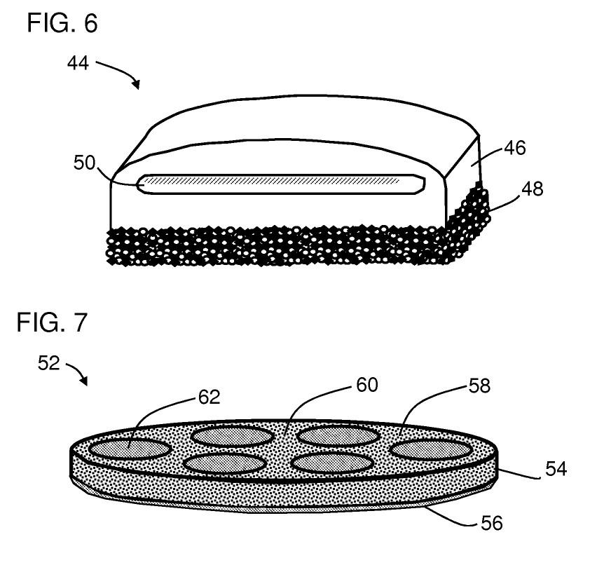

FIG. 6 shows a hand held abrasive article suitable for hand sanding applications comprised of a handle portion fixedly attached to wearable abrasive surface.

FIG. 6 shows a hand held abrasive article that may be used to sand automotive surfaces. Hand held abrasive article 44 is shown comprising a main handle portion 46 and a major abrasive surface working portion 48. Also shown is side groove 50. Side groove 50 provides an ergonomic fit to the hand for easier use. Hand held abrasive article 44 is shown having major abrasive surface portion 48 fixedly attached to main handle portion 46. Major abrasive surface portion 48 may be comprised of the abrasive sanding composition of FIG. 4.

FIG. 7 shows a dual action sanding pad having a pattern of two different foam abrasive compositions. Abrasive dual action sanding pad 52 is shown having top abrasive pad portion 54 attached to soft Velcro (hook and loop) attachment portion 56. Also shown is top exposed major sanding surface portion 58. Dual action sanding pad 52 attaches to a Dual action sanding tool with Velcro (hook and loop) attachment portion 56. Top abrasive pad portion 54 is shown having a first abrasive foam composition having a first grit value forming a first zone matrix portion 60 with and a second abrasive foam composition having a second grit value filling in matrix portion 60 forming a second zone 62.

The multiple abrasive formulation illustrated in dual action sanding pad 52 provides further control of wear rate and modification of sanding properties. Described below is an example.

A mold was made consisting of a 6″ diameter plastic pipe having five 1.75″ diameter plastic pipes distributed in a circle having the pattern shown in FIG. 7 inside of the larger pipe. The entire inside of the mold was coated with a light film of silicone release. A first abrasive foam composition was prepared having a grit value equivalent to 320 sandpaper. This formulation was prepared as follows:

In a one gallon polyethylene plastic pail were placed 60 grams of 120 degree F. Silpak SP-328-4 A four pound rigid foam polyurethane isocyanate resin. To this were added 14 grams of 120 degree F. Silpak SP-100-8 A 8 pound flexible foam polyurethane isocyanate resin. To this were then added 20 grams of 120 degree F. Silpak siltec 75 polyurethane isocyanate resin. In a separate 1 quart polyethylene container were placed 55 grams of 120 degree F. Silpak SP-328-4 B four pound rigid foam polyurethane polyol resin. To this were added 33 grams of 120 degree F. Silpak SP-100 B 8 pound flexible foam polyurethane polyol resin. To this were then added 22 grams of 120 degree F. Silpak Siltec 75 polyurethane polyol resin. To this were then added 5 grams of Silpak SP-328-2 B two pound rigid foam polyol resin. The contents of the one quart container were thoroughly mixed until uniform. 105 grams of the polyol mixture in the one quart container were then added to the isocyanate resin mixture in the one gallon polyethylene container. The contents of the one gallon container were then mixed with a drill mixer until the resin mixture started to clarify followed by the addition of 10 grams of turpentine. The mixture was then mixed again for a period of 20 seconds until clarification was complete. The abrasive mixture consisting of 292 grams of 100 grit sandpaper grade aluminum zirconium oxide (100 N Z Plus Alum/Zirconia) from Washington Mills (Washington Mills North Grafton, Inc, 20 N. Main St, North Grafton, Mass. 01536, Tel: +1 508-839-6511) and 292 grams of 70 grit aluminum oxide at 85 degrees F. was then added to the contents of the plastic pail and mixed for 30 seconds with a drill mixer. This mixture was then poured into the 6″ diameter cylindrical mold and allowed to cure for one hour.

Once cured, the smaller 1.75″ tubes were removed from the mold leaving behind a matrix having cylindrical cavities. A batch of 180 grit abrasive foam composition was then prepared as illustrated above but replacing the 70 grit aluminum oxide abrasive with coarser 60 grit aluminum oxide abrasive. This mixture was then poured into the cylindrical voids in the first abrasive foam composition and allowed to foam up and subsequently cure. The resulting loaf was removed from the mold and cut into 0.2″ thick slices of 6″ diameter circles. The resulting pad was glued onto a hook and loop backing. The part was allowed to fully cure overnight and tested.

Sanding with this dual action sanding pad was rapid on automotive primer. The deep scratches formed by the 180 grit portion were smoothed over by the finer 320 grit matrix portion. On continued sanding it was noticed that the foam skin interface between the two grit values was harder and wore more slowly than the rest of the pad producing a cutting edge and slowing down the wear rate.

The above described sanding pad used the same resin foam mixture for both abrasive foam compositions used in the tool. It should be noted that a higher density/stronger foam composition may be used for the cylindrical abrasive foam composition or the matrix abrasive foam composition. Tools made in this way were also prepared. These tools exhibited a wear rate that was limited to that of the slower wearing abrasive composition.

Dual action sanding pads attach to dual action sanding tools.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed:

1. A composition of matter for sanding applications comprising: (a) from about 1 part by weight of a polymeric foam composition with a density of at least 8 pounds per cubic foot; and (b) from about 2.7 to about 8 parts by weight of abrasive particles, wherein said composition of matter has structural integrity and said abrasive particles have a resin coating, whereby said resin coating of said abrasive particles reduces shedding of said abrasive particles.

2. The composition of matter of claim 1 wherein said composition further comprises flex agents.

3. The composition of matter of claim 1 wherein said composition further comprises a flexible foam and a rigid foam.

4. The composition of matter of claim 1 wherein said resin coating is about 1% by weight of said abrasive particle.

5. The composition of matter of claim 1 wherein said resin coating forms chemical bonds with said polymeric foam composition.

6. The composition of matter of claim 1 further comprising a plurality of finer abrasive particles attached to said abrasive particles by said resin coating.

7. A composition of matter for sanding applications comprising: (a) from about 1 part by weight of a polymeric foam composition with a density of at least 8 pounds per cubic foot; and (b) from about 2.7 to about 8 parts by weight of abrasive particles, wherein said composition of matter has structural integrity and said abrasive particles are comprised of a first abrasive particle size having a first grit value and a second abrasive particle size having second grit value, wherein said second grit value differs by a value of at least 20 grit from said first grit value.

8. A sanding pad comprising:
a first zone of abrasive foam comprising of a first polymeric foam and first plurality of abrasive particles having a first grit value, wherein said first plurality of abrasive particles are dispersed in said first polymeric foam; and
a second zone of abrasive foam comprising of a second polymeric foam and a second plurality of abrasive particles having a second grit value, wherein said second plurality of abrasive particles are dispersed in said second polymeric foam, and wherein said second grit value is different from said first grit value.

9. The sanding pad of claim 8 wherein said first zone of abrasive foam has a lower wear rate than said second zone of abrasive foam.

10. The sanding pad of claim 8 wherein said first polymeric foam and said second polymeric foam have flex agents.

11. The sanding pad of claim 8 wherein said first polymeric foam and said second polymeric foam are comprised of a rigid polymeric foam and a flexible polymeric foam.
